(19) United States
(12) Patent Application Publication
(10) Pub. No.: US 2020/0398227 A1
(43) Pub. Date: Dec. 24, 2020

(54) DYE-SALT SEPARATION MEMBRANE AND PREPARATION METHOD THEREOF

(71) Applicant: Nanjing University of Science and Technology, Jiangsu (CN)

(72) Inventors: Jiansheng LI, Jiangsu (CN); Qin LI, Jiangsu (CN); Junwen QI, Jiangsu (CN); Xiaofeng FANG, Jiangsu (CN); Zhipeng LIAO, Jiangsu (CN); Dapeng WANG, Jiangsu (CN); Jia XIE, Jiangsu (CN); Linhan Ni, Jiangsu (CN); Xiuyun SUN, Jiangsu (CN); Lianjun WANG, Jiangsu (CN)

(73) Assignee: Nanjing University of Science and Technology, Jiangsu (CN)

(21) Appl. No.: 16/907,173

(22) Filed: Jun. 20, 2020

(30) Foreign Application Priority Data
Jun. 22, 2019 (CN) 201910545384.8

(51) Int. Cl. B01D 67/00; B01D 71/68; B01D 69/12

(52) U.S. Cl. CPC B01D 67/0013; B01D 61/145; B01D 69/12; B01D 71/68

(57) ABSTRACT

The present invention relates to a dye-salt separation membrane and a preparation method thereof. The method includes the following steps: firstly pouring an aqueous phase solution containing tannic acid and anhydrous piperazine on a surface of a polysulfone-based ultrafiltration base membrane at a mass ratio of the tannic acid to the anhydrous piperazine of 1:2 to 2:1, followed by complete infiltration, and draining the aqueous phase solution; and then pouring an organic phase solution of trimesoyl chloride on the surface of the base membrane, and draining the organic phase solution to obtain the dye-salt separation membrane. The method of the present invention is simple and easy to implement, and the dye-salt separation membrane prepared by the method has a relatively high solution permeability, an efficient dye retention and permeability of inorganic salts, thereby achieving an excellent dye-salt separation effect.

### CROSS-REFERENCE TO RELATED APPLICATION

This application claims the priority benefit of China application serial no. 201910545384.8, filed on Jun. 22, 2019. The entirety of the above-mentioned patent application is hereby incorporated by reference herein and made a part of this specification.

### BACKGROUND

### Technical Field

The present invention belongs to the technical field of nanofiltration membranes, and relates to a dye-salt separation membrane and a preparation method thereof.

### Description of Related Art

Dye-salt separation technology is a membrane technology for water treatment, which is mainly used to treat salt-containing dye wastewater. This technology uses a nanofiltration membrane which has a structure that is generally more loose than that of the traditional nanofiltration membrane, enabling effective retention of organics, such as organic dyes, with a molecular weight of 200-1000 Da, while allowing inorganic salts, such as sodium sulfate and sodium chloride, to pass through membrane pores, thereby achieving effects of separating the dyes from salts in wastewater to recover the salts and water in it (J. Membr. Sci. 2015, 477, 183-193).

At present, methods used to prepare a dye-salt separation membrane mainly include interfacial polymerization method. The interfacial polymerization is carried out by dissolving two monomers separately in an aqueous phase and an oil phase immiscible with each other, and performing a polycondensation reaction at the interface of the two solutions. In the traditional interfacial polymerization reaction, the monomer for the aqueous phase commonly used includes m-phenylenediamine, anhydrous piperazine, tannic acid and the like (Environ. Sci. Technol. 2019, 53, 1296-1304; Mater. Chem. Front., 1 (2017) 1028-1040; and J. Membr. Sci. 541 (2017) 137-142), and the monomer for the oil phase commonly used includes trimesoyl chloride (Environ. Sci. Technol. 2019, 53, 1296-1304). However, membranes prepared by the traditional interfacial polymerization usually have a high retention rate for both dyes and inorganic salts, thus not only leading to excessive osmotic pressure on the membrane surface which causes low water flux, but also losing opportunities to recover the inorganic salts from salt-containing dye wastewater when treating the wastewater, which will cause waste. Therefore, preparation of a dye-salt separation membrane capable of separating dyes from salts has become an emerging research direction.

Existing methods are different from the interfacial polymerization method used for preparing the traditional nanofiltration membrane in that when preparing the dye-salt separation membrane, in the existing methods, it is necessary to design and use brand-new polyamine monomers for interfacial polymerization (Environ. Sci. Technol. 2017, 51, 9252-9260), or to introduce appropriate nano-fillers in the traditional interfacial polymerization method to loosen the structure of the obtained membrane (J Membr. Sci. 2017, 539, 128-137). However, the design and synthesis of the new monomer molecules will complicate the preparation process of the dye-salt separation membrane, and the introduction of the nano-fillers will cause the fillers to be lost from the membrane during a filtration process, resulting in the risk of secondary contamination.

### SUMMARY

An object of the present invention is to provide a dye-salt separation membrane which is simple and easy-to-use, and has an excellent separation effect, and a preparation method thereof.

The objective of the present invention is achieved by the following technical solutions.

The present invention provides a method for preparing a dye-salt separation membrane by using a mixture of piperazine and tannic acid as a solute in an aqueous phase solution to react phenolic hydroxyl group of the tannic acid with amino group of the piperazine in water to form a longer monomer for aqueous phase, which is then subjected to interfacial polymerization with an organic phase solution of trimesoyl chloride on a high polymer ultrafiltration base membrane, the method specifically including the following steps:

step 1: pouring an aqueous phase solution containing tannic acid and anhydrous piperazine on a surface of a polysulfone-based ultrafiltration base membrane at a mass ratio of the tannic acid to the anhydrous piperazine of 1:2 to 2:1, followed by complete infiltration for 3 to 6 minutes, and then draining the aqueous phase solution;

step 2: pouring an organic phase solution of trimesoyl chloride on the surface of the polysulfone-based ultrafiltration base membrane obtained in step 1, followed by complete infiltration for 0.5 to 2 minutes, then draining the organic phase solution, and after the organic phase solution being completely evaporated, storing the resulting dye-salt separation membrane in water.

Preferably, in step 1, the polysulfone-based ultrafiltration base membrane is selected from polyethersulfone, polysulfone, or sulfonated polyethersulfone.

Preferably, in step 1, the aqueous phase solution contains the tannic acid and the anhydrous piperazine at a combined mass fraction of 0.2 wt %.

Preferably, in step 1, the infiltration is performed for a time period of 5 minutes.

Preferably, in step 1, the mass ratio of the tannic acid to the anhydrous piperazine is 1:1.

Preferably, in step 2, the organic phase solution of the trimesoyl chloride contains the trimesoyl chloride at a mass fraction of 0.1 wt %.

Preferably, in step 2, the infiltration is performed for a time period of 1 minute.

Preferably, in step 2, the organic phase solution contains a solvent selected from n-hexane or cyclohexane.

The present invention also provides a dye-salt separation membrane prepared by the above-mentioned preparation method.

The present invention has the following advantages over the prior art.

(1) The present invention adopts the method in which the readily available tannic acid and piperazine are reacted in advance, simplifying the preparation process of the dye-salt separation membrane, while any nano-fillers are not introduced, thereby avoiding the risk of secondary contamination due to the loss of the fillers.

(2) The method according to the present invention is simple and easy to implement, and for the longer monomer for the aqueous phase formed by the phenolic hydroxyl group of tannic acid reacting with the amino group of piperazine in water, regardless of whether the terminal of the monomer is the amino group of piperazine or the phenolic hydroxyl group of tannic acid, the monomer can undergo the interfacial polymerization with polyacyl chloride to enlarge pores in the membrane obtained by the interfacial polymerization, achieving a dye-salt separation effect.

(3) The dye-salt separation membrane according to the present invention has a relatively high solution permeability (up to 315.2 Lm⁻²h⁻¹MPa⁻¹), an efficient dye retention (retention rate of Congo red dye up to 99.42%) and permeability of inorganic salts (permeability of sodium chloride up to 94.59%; and permeability of sodium sulfate up to 89.69%), thereby achieving an excellent dye-salt separation effect. In addition, in the case where the dye retention and salt permeability are comparable to those in the prior art, water flux is significantly improved.

### DESCRIPTION OF THE EMBODIMENTS

The present invention will be further described below with reference to Examples.

### Example 1

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 1:2. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.48%, the permeability of sodium chloride was 93.98%, and the permeate flux was 249.4 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.64%, the permeability of sodium sulfate was 87.02%, and the permeate flux was 225.5 Lm⁻²h⁻¹MPa⁻¹.

### Example 2

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 2:1. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.28%, the permeability of sodium chloride was 94.55%, and the permeate flux was 235.4 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.32%, the permeability of sodium sulfate was 89.90%, and the permeate flux was 235.5 Lm⁻²h⁻¹MPa⁻¹.

### Example 3

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 1:1. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.42%, the permeability of sodium chloride was 94.59%, and the permeate flux was 315.2 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.19%, the permeability of sodium sulfate was 94.59%, and the permeate flux was 273.9 Lm⁻²h⁻¹MPa⁻¹.

### Comparative Example 1

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 1:4. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.71%, the permeability of sodium chloride was 72.91%, and the permeate flux was 216.4 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.69%, the permeability of sodium sulfate was 51.12%, and the permeate flux was 203.9 Lm⁻²h⁻¹MPa⁻¹.

### Comparative Example 2

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 4:1. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.70%, the permeability of sodium chloride was 84.41%, and the permeate flux was 98.4 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.59%, the permeability of sodium sulfate was 66.48%, and the permeate flux was 102.1 Lm⁻²h⁻¹MPa⁻¹.

### Example 4

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 1:1. After the formulation of the aqueous phase solution was completed, the aqueous phase solution was poured on a surface of a polysulfone ultrafiltration membrane and allowed to completely infiltrate it for 5 minutes, and then, the aqueous phase solution was drained.

Step 2: A solution containing trimesoyl chloride as a solute in n-hexane at a mass fraction of 0.1 wt % was formulated. After the formulation was completed, the solution was poured on the surface of the polysulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.58%, the permeability of sodium chloride was 95.05%, and the permeate flux was 286.3 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.33%, the permeability of sodium sulfate was 90.96%, and the permeate flux was 272.1 Lm⁻²h⁻¹MPa⁻¹.

### Example 5

Step 1: An aqueous phase solution containing a mixture of tannic acid and anhydrous piperazine as a solute at a combined mass fraction of 0.2 wt % was formulated. The mass ratio of tannic acid to anhydrous piperazine in the mixture was 1:1. After the formulation of the aqueous phase solution was completed, the aqueous phase solution was poured on a surface of a polyethersulfone ultrafiltration membrane and allowed to completely infiltrate it for 5 minutes, and then, the aqueous phase solution was drained.

Step 2: A solution containing trimesoyl chloride as a solute in cyclohexane at a mass fraction of 0.1 wt % was formulated. After the formulation was completed, the solution was poured on the surface of the polyethersulfone ultrafiltration membrane treated in step 1 and allowed to completely infiltrate it for 1 minute, and then the organic phase solution was drained. After the organic phase solution was completely evaporated, the resulting dye-salt separation membrane was placed in deionized water for storage.

Separation performance test 1: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium chloride, the retention rate of Congo red was 99.34%, the permeability of sodium chloride was 94.48%, and the permeate flux was 313.0 Lm⁻²h⁻¹MPa⁻¹.

Separation performance test 2: The resulting dye-salt separation membrane was installed in a membrane separation device in which the differential pressure across the membrane was controlled to 0.4 MPa, and it was determined that at room temperature, for a dye-salt aqueous solution containing 0.2 g/L of Congo red and 2 g/L of sodium sulfate, the retention rate of Congo red was 99.16%, the permeability of sodium sulfate was 91.68%, and the permeate flux was 294.7 Lm⁻²h⁻¹MPa⁻¹.

What is claimed is:

1. A method for preparing a dye-salt separation membrane, comprising the following steps:
step 1: pouring an aqueous phase solution containing tannic acid and anhydrous piperazine on a surface of a polysulfone-based ultrafiltration base membrane at a mass ratio of the tannic acid to the anhydrous piperazine of 1:2 to 2:1, followed by complete infiltration for 3 to 6 minutes, and then draining the aqueous phase solution; and
step 2: pouring an organic phase solution of trimesoyl chloride on the surface of the polysulfone-based ultrafiltration base membrane obtained in step 1, followed by complete infiltration for 0.5 to 2 minutes, then draining the organic phase solution, and after the organic phase solution being completely evaporated, storing the resulting dye-salt separation membrane in water.

2. The method according to claim 1, wherein in step 1, the polysulfone-based ultrafiltration base membrane is selected from polyethersulfone, polysulfone, or sulfonated polyethersulfone.

3. The method according to claim 1, wherein in step 1, the aqueous phase solution contains the tannic acid and the anhydrous piperazine at a combined mass fraction of 0.2 wt %.

4. The method according to claim 1, wherein in step 1, the infiltration is performed for a time period of 5 minutes.

5. The method according to claim 1, wherein in step 1, the mass ratio of the tannic acid to the anhydrous piperazine is 1:1.

6. The method according to claim 1, wherein in step 2, the organic phase solution of the trimesoyl chloride contains the trimesoyl chloride at a mass fraction of 0.1 wt %.

7. The method according to claim 1, wherein in step 2, the infiltration is performed for a time period of 1 minute.

8. The method according to claim 1, wherein in step 2, the organic phase solution contains a solvent selected from n-hexane or cyclohexane.

9. A dye-salt separation membrane prepared by the method according to claim 1.

10. A dye-salt separation membrane prepared by the method according to claim 2.

11. A dye-salt separation membrane prepared by the method according to claim 3.

12. A dye-salt separation membrane prepared by the method according to claim 4.

13. A dye-salt separation membrane prepared by the method according to claim 5.

14. A dye-salt separation membrane prepared by the method according to claim 6.

15. A dye-salt separation membrane prepared by the method according to claim 7.

16. A dye-salt separation membrane prepared by the method according to claim 8.
